(19) United States
(12) Patent Application Publication
(10) Pub. No.: US 2025/0329264 A1
(43) Pub. Date: Oct. 23, 2025

(54) ADAPTIVE GAME-BASED RISK ASSESSMENTS

(71) Applicant: CYBERCADE, INC, Coralville, IA (US)

(72) Inventors: Jim Sherlock, Iowa City, IA (US); Aaron Warner, Coralville, IA (US)

(21) Appl. No.: 19/185,057

(22) Filed: Apr. 21, 2025

Related U.S. Application Data
(60) Provisional application No. 63/636,593, filed on Apr. 19, 2024.

(51) Int. Cl. G09B 5/02

(52) U.S. Cl. CPC G09B 5/02

(57) ABSTRACT

A game-based security and risk management training methodology and system are described. The system outputs a game-based security learning program to a client device, the game-based security learning program comprising a first set of one or more adaptive learning modules. The system monitors one or more indications of user input of a user of the client device within at least one of the first set of one or more adaptive learning modules of the game-based security learning program. The system develops a personalized game-based security learning program for the user based on the one or more indications of user input of the user, the personalized game-based security learning program comprising a second set of one or more adaptive learning modules different than the first set of one or more adaptive learning modules. The system outputs the personalized game-based security learning program to the client device.

### RELATED APPLICATIONS

This application claims the benefit of U.S. Provisional Application No. 63/636,593, filed Apr. 19, 2024, the entire contents of which are incorporated herein by reference.

### TECHNICAL FIELD

The disclosure relates to personalized and adaptive computer security risk assessment techniques.

### BACKGROUND OF THE INVENTION

Traditional methods of training are becoming increasingly incompatible with the modern workplace and workforce. Furthermore, the concept of one-size-fits-all training is wasteful and ineffective. Companies face an average of $9.48 million per breach, with a 90% surge in breach activity since early 2023. Upwards of 74% of these breaches can be traced back to human error in handling internet security issues. As such, internal human elements may pose the greatest risk to an organization's technological security, and proper training is necessary to curb such incidents.

### SUMMARY OF THE INVENTION

In general, the disclosure describes a system that may output a game-based security learning program to a client device, the game-based security learning program comprising a first set of one or more adaptive learning modules. The system may monitor one or more indications of user input of a user of the client device within at least one of the first set of one or more adaptive learning modules of the game-based security learning program. The system may develop a personalized game-based security learning program for the user based on the one or more indications of user input of the user, the personalized game-based security learning program comprising a second set of one or more adaptive learning modules different than the first set of one or more adaptive learning modules. The system may output the personalized game-based security learning program to the client device.

The techniques described herein provide a number of benefits over one-size-fits-all training common in modern workplaces. Users complete the training with greater time efficiency, meaning that they spend less time off the job. The system results in greater competence for the users, meaning better outcomes for the organization. The question-based and game-based approach described herein provides numerous touchpoints where the system can gather learner data and better customize the game for each individual user. Additionally, each user is heterogeneous in their experiences and mannerisms, and providing personalized learning for those varied backgrounds provides for a more effective learning experience. Furthermore, when updates to modules are made, the information can simply and quickly be substituted.

In one example, the disclosure is directed to a method that includes outputting, by one or more processors, a game-based security learning program to a client device, the game-based security learning program comprising a first set of one or more adaptive learning modules. The method further includes monitoring, by the one or more processors, one or more indications of user input of a user of the client device within at least one of the first set of one or more adaptive learning modules of the game-based security learning program. The method also includes developing, by the one or more processors, a personalized game-based security learning program for the user based on the one or more indications of user input of the user, the personalized game-based security learning program comprising a second set of one or more adaptive learning modules different than the first set of one or more adaptive learning modules. The method further includes outputting, by the one or more processors, the personalized game-based security learning program to the client device.

In another example, the disclosure is directed to a computing device comprising one or more processors configured to output a game-based security learning program to a client device, the game-based security learning program comprising a first set of one or more adaptive learning modules. The one or more processors are further configured to monitor one or more indications of user input of a user of the client device within at least one of the first set of one or more adaptive learning modules of the game-based security learning program. The one or more processors are also configured to develop a personalized game-based security learning program for the user based on the one or more indications of user input of the user, the personalized game-based security learning program comprising a second set of one or more adaptive learning modules different than the first set of one or more adaptive learning modules; and. The one or more processors are further configured to output the personalized game-based security learning program to the client device.

In another example, the disclosure is directed to a non-transitory computer-readable storage medium containing instructions. The instructions, when executed, cause one or more processors to output a game-based security learning program to a client device, the game-based security learning program comprising a first set of one or more adaptive learning modules. The instructions, when executed, further cause one or more processors to monitor one or more indications of user input of a user of the client device within at least one of the first set of one or more adaptive learning modules of the game-based security learning program. The instructions, when executed, also cause one or more processors to develop a personalized game-based security learning program for the user based on the one or more indications of user input of the user, the personalized game-based security learning program comprising a second set of one or more adaptive learning modules different than the first set of one or more adaptive learning modules. The instructions, when executed, further cause one or more processors to output the personalized game-based security learning program to the client device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is an example user interface illustrating a game-based security learning program, in accordance with the techniques of this disclosure.

FIG. 2 is a block diagram illustrating a more detailed example of a computing device configured to perform the techniques described herein.

FIG. 3 is an example user interface illustrating results of the game-based security learning program for a user, in accordance with the techniques of this disclosure.

FIG. 4 is an example user interface illustrating a player profile for a user of the game-based security learning program, in accordance with the techniques of this disclosure.

FIG. 5 is a flow diagram illustrating an example technique for developing a personalized game-based security learning program, in accordance with the techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

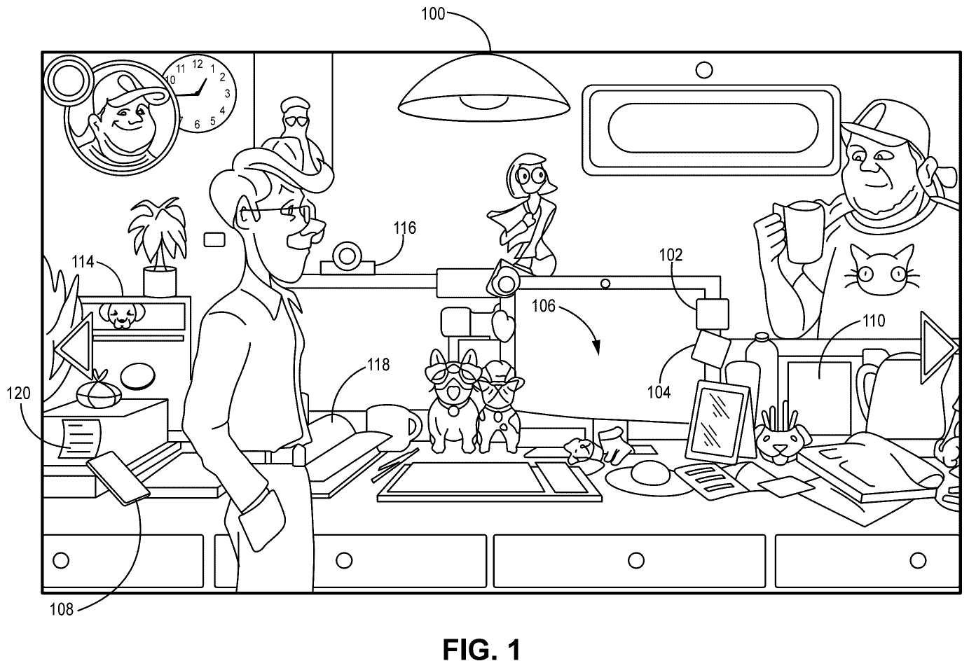

FIG. 1 is an example user interface 100 illustrating a game-based security learning program, in accordance with the techniques of this disclosure. User interface 100 shows an office setting with a game-like aesthetic. In user interface 100, the user may be tasked with identifying various security risks during a risk management and internet security learning module. Based on the user's performance in identifying the 15 objects that may prove to be a security risk, the system may analyze the various indications of user input throughout the game to evaluate the user's competency in this module. Based on this input, the system may proceed to personalize and change different aspects of the learning program such that the game-based security learning program is providing captivating and interactive modules that simultaneously engage the user and address areas of interest and/or weakness of the user.

In user interface 100 of example FIG. 1, the objects may be any objects that could be a security risk exploitable by an attacker, either physically located in the space or virtually. Examples in FIG. 1 include sticky note 102 and sticky note 104, each of which may include various personal or network passwords, a logged-in computing system 106, a loose identification badge 108, a page with contact information 110, a loose credit card 112, a physical calendar viewable to the public 114, a plugged in and active webcam 116, a physical page of notes 118, and invoice 120. In one example of the game,

In accordance with the techniques of this disclosure, a system may output a game-based security learning program to a client device, the game-based security learning program comprising a first set of one or more adaptive learning modules. The system may monitor one or more indications of user input of a user of the client device within at least one of the first set of one or more adaptive learning modules of the game-based security learning program. The system may develop a personalized game-based security learning program for the user based on the one or more indications of user input of the user, the personalized game-based security learning program comprising a second set of one or more adaptive learning modules different than the first set of one or more adaptive learning modules. The system may output the personalized game-based security learning program to the client device.

In today's rapidly evolving digital landscape, organizations face significant challenges in maintaining robust cybersecurity defenses. Traditional training methods, often characterized by static and generic content, have proven increasingly inadequate in addressing the dynamic nature of cybersecurity threats. These conventional approaches typically adopt a one-size-fits-all model, which fails to account for the diverse backgrounds, skills, and learning paces of individual employees. As a result, such training programs often lead to disengagement and fail to effectively mitigate human error, a leading cause of security breaches.

The limitations of existing methods in cybersecurity training are further exacerbated by the high costs associated with data breaches. Organizations are experiencing a surge in breach activity, with human error being a primary contributor. Despite the significant need for effective training, current solutions do not adequately address the individual learning needs of each employee, nor do they provide the flexibility required to adapt to rapidly changing security landscapes. This lack of personalization and adaptability results in inefficient training processes, where employees spend excessive time on irrelevant content, leading to suboptimal security outcomes.

The techniques described herein address these challenges by introducing an novel approach for personalized and adaptive computer security risk assessment. This approach leverages a game-based security learning program that is dynamically tailored to the individual user. By monitoring user interactions and inputs within the program, the system develops a personalized learning experience that adapts to the user's specific needs and competencies. This method not only enhances engagement and learning efficiency but also significantly improves the overall security posture of the organization by effectively addressing both conscious and unconscious incompetence in cybersecurity practices.

The techniques described herein provide a number of benefits over one-size-fits-all training common in modern workplaces. Users complete the training with greater time efficiency, meaning that they spend less time off the job. The system results in greater competence for the users, meaning better outcomes for the organization. The question-based and game-based approach described herein provides numerous touchpoints where the system can gather learner data and better customize the game for each individual user. Additionally, each user is heterogeneous in their experiences and mannerisms, and providing personalized learning for those varied backgrounds provides for a more effective learning experience. Furthermore, when updates to modules are made, the information can simply and quickly be substituted. The method provides a personalized learning experience by adapting the game-based security program to the user's specific needs, enhancing engagement and effectiveness in cybersecurity training.

Traditional methods of training are becoming increasingly incompatible with the modern workplace and workforce. Furthermore, the concept of one-size-fits-all training is wasteful and ineffective. Adaptive learning focuses on the delivery of more user-centric learning. It uses technology and a data-driven approach that considers individual user performance, engagement, strengths, and weaknesses, to create customized learning experiences. The results are an increase in user engagement and overall motivation.

The techniques described herein may result in greater time efficiency, and less time off the job. A personalized adaptive approach can cut in half the amount of time it takes the typical learner to achieve mastery, compared to other learning approaches. With one client project, for example, a two-and-a-half-day instructor-led course was converted to a series of adaptive learning modules. Most learners mastered the adaptive material in less than eight hours, and some achieved mastery in as little as four hours.

The reason is the personalized approach, which adapts to each learner. There is no need to reteach what people already know; instead, adaptive learning focuses on where they need to become competent. For workers in fields such as call centers, retail, or nursing, where time off the floor is critical, or for expensive resources like salespeople, improving time efficiency in training is crucial.

The techniques described herein may result in greater competence, meaning better outcomes. Across every industry, there is a need to improve employee proficiency by identifying and addressing competency gaps. In the best-case scenario, employees are aware of what they do not know, meaning they are “consciously incompetent.” In the worst-case scenario, which is becoming more common, employees are unaware of the gaps in their understanding: they are “unconsciously incompetent.” Such ignorance can be very costly to the company and the satisfaction of its customers. Addressing conscious and unconscious incompetence is of the greatest importance when learning outcomes have clear consequences, such as driving revenue, improving safety, or addressing customer satisfaction. “Unconscious incompetence” is the source of many workplace errors and potentially serious ones. The best training course cannot be effective if it is not capable of identifying and remediating unconscious incompetence. Adaptive learning is unique in its ability to both identify and remediate for unconscious incompetence.

A question-based and game-based approach, as described herein, gathers learner data. Adaptive learning takes a question-based approach to learning, probing what the learner already knows and where they have gaps. The result is a large volume of very granular data, which makes it possible to analyze groups' performance as a whole, in particular areas, or even on specific questions.

Adaptive learning also keeps track of what people learned, so if training needs to be updated, the course can be modified and made available to learners without worrying about material being redundant. Equally important, using a question-based approach helps build confidence along with competence as learners gain mastery and become surer of what they know.

The techniques described herein may result in personalized learning for a heterogeneous group. Learners within any group are never the same. Tenure in position or in the company, as well as the skills, knowledge, and experiences a person brings from previous jobs or the outside world, all make each individual unique. Even individual learners are not the same day to day due to mood, health, their morning commute, even subtle choices such as drinking tea have been shown to affect learning and memory.

Adaptive learning is ideally suited to heterogeneous audiences, which, in reality, means all audiences of actual people. Adaptive learning adjusts to novices and experts alike, avoiding the dreaded “one size fits none” of traditional e-learning with its static content.

The techniques described herein may result in moving away from “Check the Box” compliance. In the corporate world, a subset of courses is often required to be taken repeatedly, year after year. Unfortunately, these tend to be dry and uninteresting from a content perspective. Compliance courses are perfect examples, despite them being critical to mitigate material risk to the company. Nonetheless, when people are forced to review dry content to simply “check the box” that they completed the course, very little learning typically happens, which undermines the original purpose of mitigating risk. “Test-out” strategies allow employees who can prove they know the material to skip the course. However, these tests are approximations of the real world. Additionally, percents in a test end up with arbitrary thresholds that may become meaningless. If someone scores a 90 percent, they are either forced to take the training, wasting their time as they cover material they already know while becoming disengaged, or 90 percent is deemed “good enough” without validating the risk associated with the missing 10 percent.

Because of adaptive learning having a question-based approach that involves the learner, even dry material becomes more engaging. It also allows people who are relatively proficient, thanks to taking repeated courses multiple times, to skip over what they have already mastered and focus only on what they do not know. By combining the assessment and the learning content into the adaptive engine, duplication is avoided while remediating unconscious incompetence and the risk associated with it.

The techniques described herein may result in more easily updating training when information changes frequently. Traditional approaches to training are not well-suited to information that changes rapidly. In face-to-face instruction, the teacher can deliver the most up-to-date material. Traditional online approaches do not accurately track what people have learned and could not adjust if they did, which makes it difficult to add new material without making learners go through everything again (wasting time and reducing engagement). Adding the new material as an addendum may work for those who have already taken the course, but it can confuse new learners. To avoid such messiness, companies often limit the number of updates, but that delays new information getting out to the employees.

The solution presented by the techniques described herein is adaptive learning. When changes to the course are introduced, the system can differentiate between material a learner has already covered and new areas to be mastered. In fact, two people could take the same course, and the system would behave differently depending on the amount of content each learner was previously exposed to. Adaptive learning also provides the ability to incrementally author content, releasing the highest-priority subjects first and then adding new content to the system.

Throughout this disclosure, reference and examples of xAPI statements will be provided. However, it is to be understood that any structured data mechanism that may capture and provide similar data for recording and reporting information regarding user input into the game-based security learning program may be utilized in place of xAPI statements, and xAPI statements are only described as one example of a data mechanism that could enable the techniques described herein.

As players progress through security learning games, the platform collects and transmits messages (in, for example, xAPI format) that describe the player's in-game experience. At their core, these xAPI statements consist of 1) An Actor, 2) A Verb, and 3) An Object. >>>example::Jim completed phishing puzzle #1.

These data mechanisms help the system understand player strengths and weaknesses. xAPI can track detailed data on player performance within the game. This could include things like the speed of response to a cybersecurity threat, the accuracy of responses, and the types of threats a player deals with most effectively. By analyzing this data, the game can adapt to focus more on areas where the player needs to improve.

These data mechanisms allow for dynamic difficulty adjustments. The game can use xAPI data to dynamically adjust the difficulty level of the game. For example, if a player is consistently dealing with a certain level of cybersecurity threat easily, the game could increase the difficulty level of threats, or introduce more complex threats to provide a continuous challenge and learning curve.

These data mechanisms further allow for personalized learning paths. xAPI data can be used to create personalized learning paths within the game. For instance, if a player is showing interest in a specific area of cybersecurity, the game could offer more activities or scenarios related to that area

These data mechanisms may further allow for competency-based progression. If the game is designed around specific competencies (e.g., identifying phishing attempts, securing networks, etc.), xAPI can help track the player's progress towards mastering these competencies. Once a player has demonstrated a certain level of competence, they could be moved on to more advanced tasks.

These data mechanisms further allow for improved feedback and guidance. xAPI can track the mistakes and incorrect choices the players make, which can provide valuable data to inform feedback. This feedback can then be used to guide the player and help them understand where they went wrong, thus helping them learn and improve.

This all allows for social learning. The game may include social or collaborative elements, xAPI can track these interactions as well. By understanding how players are interacting with each other and how these interactions are impacting learning, the systems described herein can adapt the game to encourage more effective collaboration.

These data mechanisms also allow for predictive analysis. By examining the trends and patterns in xAPI data, the systems described herein can even predict player performance and preemptively adjust the game to better meet the needs of the player.

Implementing xAPI analytics in everyday business workflows allows for capturing a wide range of learning experiences and behaviors that contribute to a comprehensive understanding of an individual's competencies and the effectiveness of security awareness training. In essence, the scenarios described below are part of a comprehensive methodology for quantifying human risk at the individual level. While in-game observations are an integral component to this methodology, it does not constitute the entirety of larger human risk measurement efforts. Here are some examples of how xAPI can be integrated into various business contexts:
Phishing Detection: Track when employees correctly identify and report phishing attempts in their regular email workflows. An xAPI statement is sent every time an employee clicks the “Report Phishing” button in their email client.
Secure Email Practices: Send xAPI statements when employees use encryption for sensitive emails or follow proper procedures for sending attachments.
Accessing Secure Documents: Generate xAPI statements when employees access secure documents, demonstrating adherence to security policies.
Sharing Documents: Track when and how documents are shared within and outside the organization, ensuring that sharing practices meet security guidelines.
Safe Browsing: Send xAPI statements when an employee accesses a company-approved safe browsing training module or successfully avoids visiting flagged websites.
Downloading Resources: Track downloads of software or documents from approved sources, sending xAPI statements to record compliance with company policies.
Security Feature Utilization: When employees enable or properly configure security features in software applications, such as two-factor authentication or firewalls, an xAPI statement is sent.
Password Management: Generate xAPI statements when employees update their passwords in compliance with company policies or when they use a password manager.

### Physical Security

Secure Workspace: Track security badge swipes and access to secure areas within the company's physical premises to ensure employees are only accessing areas they are authorized to.
Device Security: Send xAPI statements when employees secure their devices, either by locking screens when away or reporting lost/stolen equipment promptly.
Incident Identification: Capture when an employee identifies and reports a security incident or anomaly in their regular workflow.
Response to Simulated Incidents: In simulated incident response drills, track how employees react and which actions they take, from identification to resolution.
Microlearning Engagement: Track employee engagement with short, targeted security training exercises that are integrated into their daily workflows.
Peer Teaching: When an employee contributes to a peer's security learning by providing tips or guidance, capture this with an xAPI statement, highlighting collaborative learning.
Security in Discussions: Track mentions and discussions of security best practices in meetings, indicating an ongoing awareness and consideration of security in business operations.
Vendor Compliance: When interacting with vendors or third parties, track the due diligence activities of employees, such as verifying security certifications or ensuring contracts include necessary security clauses.

Below is an example of what an xAPI statement, or any other structured data mechanism, could resemble in implementation:

```
      {
        “actor”: {
          “mbox”: “mailto:parens@cybercade.com”,
          “name”: “Paul Arens”,
          “objectType”: “Agent”
        },
        “verb”: {
          “id”: “http://adlnet.gov/expapi/verbs/answered”,
          “display”: {
            “en-US”: “answered”
          }
        },
        “object”: {
          “id”: “https://demo.cybercadegames.com/scene1/main1/question/1”,
          “definition”: {
            “name”: {
              “en-US”: “Desk Object Identification”
            },
            “description”: {
              “en-US”: “Paul Arens identified a ‘To-Do List’ on the desk as ‘Risky’.”
            },
            “type”: “http://adlnet.gov/expapi/activities/question”
          }
        },
        “result”: {
          “success”: false,
          “completion”: true,
          “duration”: “PT89S”,
          “response”: “To-Do List: Risky”
        },
        “context”: {
          “contextActivities”: {
            “category”: [
              {
                “id”: “https://demo.cybercadegames.com”,
                “definition”: {
                  “name”: {
                    “en-US”: “Adventures In Cybersecurity - Chapter 1”
                  }
                }
              }
            ]
          },
          “extensions”: {
            “http://example.com/extensions/selectedObject”: “To-Do List”,
            “http://example.com/extensions/playerSelection”: “Risky”,
            “http://example.com/extensions/gameFeedback”: “Incorrect”,
            “http://example.com/extensions/learningObjective”: [
              “NIST Cybersecurity Framework - Physical Security”
            ],
            “http://example.com/extensions/nistCSFPillar”: “Protect”,
            “http://example.com/extensions/gameType”: “Chapter”,
            “http://example.com/extensions/gameTitle”: “Adventures In
Cybersecurity - Chapter 1”,
            “http://example.com/extensions/currentScene”: 1,
            “http://example.com/extensions/currentURL”:
“https://demo.cybercadegames.com/scene1”,
            “https://cybercade.com/xapi/extension/player-rank”: “Level 2”,
            “https://cybercade.com/xapi/extension/player-department”:
“Engineering”,
                  “https://cybercade.com/xapi/extension/elapsedTime”: “PT89S”
          }
        },
        “timestamp”: “2023-11-10T19:22:21.792395”
      }
```

By integrating xAPI into these diverse aspects of everyday work, the systems described herein can create a rich data stream that not only measures compliance with security policies but also encourages a culture of security mindfulness throughout an organization. This data can then be used to personalize future training, improve company security policies, and ultimately strengthen the overall security posture of a company.

The techniques described herein may further utilize advanced artificial intelligence to tailor customizations to the individual or the organization. One example is in the policy guidance offered through training. By leveraging artificial intelligence, the techniques described herein may analyze a cybersecurity policy for a company to provide users with specific instructions relevant to their organization rather than relying on generic guidance from authorities like NIST. Additionally, the techniques described herein may customize communications based on each individual's game status and demographics, enhancing their engagement. Customization is at the core of our platform, driving both effectiveness and engagement. This approach ensures that each participant gains maximum benefit from their learning experience.

The techniques described herein further allow subscribers to craft custom scenarios and games using an artificial intelligence-based assistant that helps create all aspects of the game, from the images to the actual story. The assistant guides the user through the learning objectives, characters, etc., and builds out a “choose your own adventure” to address the specific subjects being taught.

This approach leverages artificial intelligence to move beyond static, pre-programmed training modules. Instead, the artificial intelligence engine acts as a dynamic content generator, continuously analyzing individual user data, including their specific role within the company, historical performance in previous game scenarios, identified knowledge gaps, learning style, and behavioral patterns observed during gameplay, among other things. Based on this comprehensive profile, the artificial intelligence intelligently constructs and modifies game environments, challenges, and narratives in real-time. For instance, a user in the finance department might receive scenarios centered around financial data security threats, while an IT administrator might face challenges related to network vulnerabilities, with the difficulty and specific attack vectors adapting based on their demonstrated proficiency and past errors.

Furthermore, while static systems may be limited to selecting from a library of pre-existing components, the artificial intelligence system described herein may dynamically assemble new scenarios or modify existing ones to address emerging threats or specific policy nuances relevant to the user's context. By integrating information about the company's actual cybersecurity policies and the user's engagement with previous training content, the artificial intelligence can create highly relevant and timely simulations. This ensures the training remains fresh, challenging, and directly applicable to the user's daily responsibilities and the current threat landscape, fostering deeper engagement and retention compared to generic training.

This dynamic generation process allows the system to pinpoint and target areas of “unconscious incompetence”, or areas where users may be unaware of their lack of knowledge or poor habits. The artificial intelligence can construct specific micro-scenarios designed to expose these blind spots in a safe, simulated environment. By continuously adapting the training content based on performance feedback and evolving user profiles, the system ensures that each user receives a truly personalized learning journey that efficiently addresses their unique risk factors and builds competence where it's needed most, ultimately contributing to a stronger overall security posture for the organization.

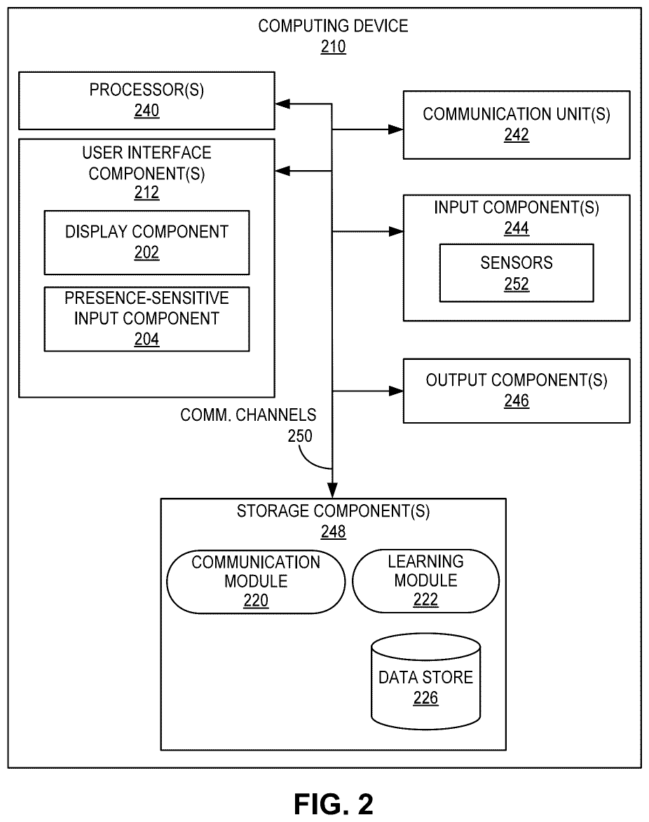

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, learning module 222, and data store 226.

One or more processors 240 may implement functionality and/or execute instructions associated with computing device 210 to generate personalized game-based security learning programs. That is, processors 240 may implement functionality and/or execute instructions associated with computing device 210 to output a game-based security learning program and adapt and personalize said game-based security learning program for a more efficient and effective training program.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to generate personalized game-based security learning programs.

Communication module 220 may execute locally (e.g., at processors 240) to provide functions associated with managing a user interface (e.g., user interfaces 100, 300, and 400) that computing device 210 provides at UIC 212 for example, for outputting interactive game-based security learning programs and receiving user input within the various modules of the program. In some examples, communication module 220 may act as an interface to a remote service accessible to computing device 210. For example, communication module 220 may be an interface or application programming interface (API) to a remote server that outputs interactive game-based security learning programs and receives user input within the various modules of the program.

In some examples, learning module 222 may execute locally (e.g., at processors 240) to provide functions associated with altering the game-based security learning programs to develop personalized programs for each individual user participating in the security learning program. In some examples, learning module 222 may act as an interface to a remote service accessible to computing device 210. For example, learning module 222 may be an interface or application programming interface (API) to a remote server that alters the game-based security learning programs to develop personalized programs for each individual user participating in the security learning program.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may output a game-based security learning program to a client device, the game-based security learning program comprising a first set of one or more adaptive learning modules. Learning module 222 may monitor one or more indications of user input of a user of the client device within at least one of the first set of one or more adaptive learning modules of the game-based security learning program.

Learning module 222 may develop a personalized game-based security learning program for the user based on the one or more indications of user input of the user, the personalized game-based security learning program comprising a second set of one or more adaptive learning modules different than the first set of one or more adaptive learning modules.

In some instances, in developing the second set of one or more adaptive learning modules for the personalized game-based security learning program learning module 222 may change a difficulty of a first module in the first set of one or more adaptive learning modules to a different difficulty for a first module in the second set of one or more adaptive learning modules. Additionally or alternatively, learning module 222 may remove the first module from the first set of one or more adaptive learning modules from inclusion in the second set of one or more adaptive learning modules. Additionally, alternatively, or in any combination, learning module 222 may add a new module to the second set of one or more adaptive learning modules, wherein the new module is not included in the first set of one or more adaptive learning modules. Additionally, alternatively, or in any combination, learning module 222 may edit the first module in the first set of one or more adaptive learning modules to develop an edited module for inclusion in the second set of one or more adaptive learning modules. Additionally, alternatively, or in any combination, learning module 222 may add, an explanation within the first module in the first set of one or more adaptive learning modules to develop an explanatory module for inclusion in the second set of one or more adaptive learning modules. The ability to modify learning modules based on user performance ensures that the training remains relevant and challenging, promoting continuous learning and skill development.

Communication module 220 may output the personalized game-based security learning program to the client device.

In some examples, learning module 222 may calculate a human risk score for the user based at least in part on the one or more indications of user input, quantifying the user's performance in the game-based security learning program. By calculating a human risk score, the system quantifies user performance, allowing for targeted improvements in security awareness and behavior.

In some examples, in monitoring the one or more indications of user input, learning module 222 may develop one or more structured data mechanisms for recording and reporting in-game behavior of the user. In such instances, learning module 222 may develop the personalized game-based security learning program based at least in part on the one or more structured data mechanisms. The use of structured data mechanisms for monitoring user input enables detailed tracking and analysis of user behavior, facilitating more precise personalization of the learning program. In some such instances, the one or more structured data mechanisms each comprise an xAPI statement. Incorporating xAPI statements as structured data mechanisms allows for standardized data collection and interoperability with other systems, enhancing the robustness of user behavior analysis.

In some examples, learning module 222 may further determine an interest level in a first subject type of module in the first set of one or more adaptive learning modules. In such examples, learning module 222 may determine that the interest level meets a threshold interest level and develop the personalized game-based security learning program by adding additional modules of the first subject type to the second set of one or more adaptive learning modules. By assessing and responding to user interest levels, the system can tailor content to maintain user engagement and motivation, leading to more effective learning outcomes.

In some examples, in monitoring the one or more indications of user input, learning module 222 may determine one or more activity characteristics of the one or more indications of user input. In such examples, learning module 222 may develop the personalized game-based security learning program based at least in part on the one or more activity characteristics of the one or more indications of user input. Monitoring activity characteristics of user input allows the system to adapt the learning program based on real-time user interactions, improving the relevance and impact of the training. In some such instances, the one or more activity characteristics may include any one or more of a speed of a response, an accuracy of the response, a type of security threat the user effectively handled, a progression of the user input towards a final accurate response, and an engagement of the user. Analyzing specific activity characteristics such as response speed and accuracy provides insights into user competencies, enabling targeted interventions to address weaknesses.

In some examples, in monitoring the one or more indications of user input, learning module 222 may track a progress of the user towards mastering a particular skill competency. Tracking user progress towards skill mastery ensures that the training program supports users in achieving competency, enhancing overall security awareness.

In some examples, learning module 222 may track performance for a plurality of users across an organization. The performance may include information descriptive of any one or more of an organizational score, a rank of the user within the organization, and a rank of the user within a role held by the user within the organization. By tracking organizational performance metrics, the system provides insights into the collective security posture, enabling strategic improvements across the organization.

In some examples, in developing the personalized game-based security learning program, learning module 222 may predict user performance in the personalized game-based security learning program based on the one or more indications of user input on the game-based security learning program. In such examples, learning module 222 may preemptively adjust at least one module in the second set of one or more adaptive learning modules based on the predicted user performance. Predicting user performance and preemptively adjusting learning modules ensures that the training remains aligned with user capabilities, optimizing learning efficiency.

In some examples, learning module 222 may construct a player profile for the user. Constructing a player profile allows for a comprehensive understanding of user strengths and weaknesses, facilitating personalized learning paths. The player profile may include information descriptive of any one or more of a job title of the user, a job responsibility list for the user, a game performance for the user, a human risk score for the user, an indication of areas of strength for the user, an indication of areas of weakness for the user, social media use for the user, dark web information of the user, a phishing simulation capability, and internet use descriptors for the user. Including detailed user information in the player profile supports a holistic approach to security training, addressing both technical skills and behavioral aspects. In some such instances, in developing the personalized game-based security learning program, learning module 222 may develop the personalized game-based security learning program based on the player profile of the user. Developing the learning program based on the player profile ensures that the training is tailored to the user's specific context and needs, maximizing its effectiveness.

In some instances, learning module 222 may concatenate information descriptive of the one or more indications of user input into a prompt (e.g., learning module 222 may concatenate the various xAPI statements produced during the game-based security learning program). In such instances, learning module 222 may feed the prompt into a large language model (or any other generative artificial intelligence model). Learning module 222 may generate, using the large language model, a narrative summary of a performance of the user in the game-based security learning program. Generating narrative summaries of user performance provides actionable insights for both users and administrators, supporting continuous improvement in security practices.

In some instances, learning module 222 may analyze, using an artificial intelligence model stored in data store 226, one or more cybersecurity policies for an organization to develop one or more specific instructions for the personalized game-based security learning program relevant to the organization. Learning module 222 may develop the personalized game-based security learning program further based on the one or more specific instructions. Analyzing organizational cybersecurity policies with AI models allows for the development of tailored instructions, ensuring that the training aligns with specific organizational needs.

In some instances, learning module 222 may generate, using an artificial intelligence model stored in data store 226, one or more custom communications for a user of the client device based on performance of the user during the personalized game-based security learning program. Communication module 220 may output at least one of the one or more custom communications to the client device. Creating custom communications based on user performance enhances the relevance and impact of feedback, promoting positive behavioral changes in security practices.

In some instances, learning module 222 may generate, using an artificial intelligence model stored in data store 226, a first request for input. Communication module 220 may output the first request for input to an administrator device (e.g., a computing device operated by an administrator-level personnel). Communication module 220 may receive an indication of first user input responding to the first request for input, with learning module 222 generating, using the artificial intelligence model and based at least in part on the first user input, a second request for input. Communication module 220 may output the second request for input to the administrator device. Communication module 220 may receive an indication of second user input responding to the second request for input. In such instances, learning module 222 may develop the personalized game-based security learning program based at least in part on the first user input and the second user input, thereby creating a customized learning program specific to the organization implementing the program. Engaging administrators in the input process ensures that the training program incorporates expert insights, enhancing its relevance and effectiveness for users.

The techniques described herein provide a transformative approach to cybersecurity training through personalized and adaptive learning techniques. By leveraging game-based modules, the system dynamically adjusts to individual user inputs, creating a tailored learning experience that significantly enhances engagement and effectiveness. This method addresses the critical issue of human error in cybersecurity by providing a customized training pathway that adapts to the user's specific needs, competencies, and interests.

The invention introduces several technical advancements. Firstly, the use of structured data mechanisms, such as xAPI statements, allows for detailed tracking and analysis of user behavior, enabling precise personalization of the learning program. This data-driven approach ensures that the training remains relevant and challenging, promoting continuous learning and skill development.

Additionally, the system's ability to calculate human risk scores and predict user performance provides quantifiable metrics that can be used to assess and improve security awareness and behavior. By incorporating artificial intelligence models to analyze organizational cybersecurity policies, the invention ensures that the training aligns with specific organizational needs, enhancing its relevance and impact.

Furthermore, the invention's capability to construct comprehensive player profiles and generate narrative summaries of user performance supports a holistic approach to security training, addressing both technical skills and behavioral aspects. This personalized learning experience not only improves individual competency but also strengthens the overall security posture of the organization.

Overall, the invention's innovative use of adaptive learning techniques, data-driven personalization, and AI-driven analysis represents a significant advancement in cybersecurity training, providing a robust solution to mitigate human error and enhance organizational security. These technical benefits address a critical problem in the field of cybersecurity.

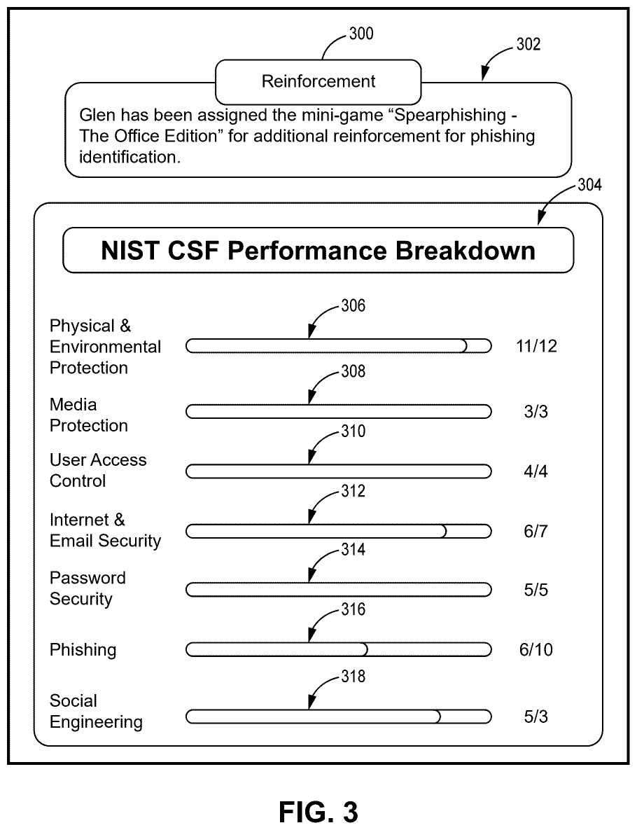

FIG. 3 is an example user interface 300 illustrating results of the game-based security learning program for a user, in accordance with the techniques of this disclosure. After a user has completed one or more adaptive learning modules in the game-based security learning program, the system may evaluate the user's performance in the various modules and output performance breakdown 304. As shown in user interface 300, the system determined the user to have received maximum marks in “Media Protection” 308, “User Access Control” 310, and “Password Security” 314, high marks in “Physical & Environmental Protection” 306, “Internet & Email Security” 312, and “Social Engineering” 318, and lower marks in “Phishing” 316. The system analyzes these results to personalize the game-based security learning game for this user, and the system assigns the user a module/mini-game entitled “Spearphishing—The Office Edition,” as shown in the generated and outputted “Reinforcement” section 302.

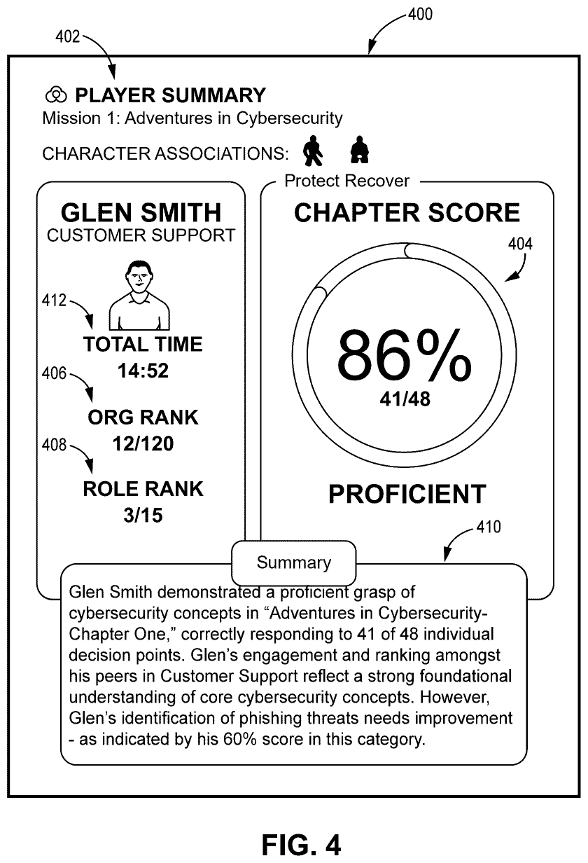

FIG. 4 is an example user interface 400 illustrating a player profile 402 for a user of the game-based security learning program, in accordance with the techniques of this disclosure. The player profile 402 and summary 410 for this user shows that they are 86% proficient in the individual decision points, represented in chapter score 404. They rank 12^{th} in the organization overall (shown in org rank 406), 3^{rd} within their role as a customer support agent (shown in role rank 408), and they completed the training in 14 minutes and 52 seconds (shown in total time 412). They have completed a first mission.

In summary section 410, the system may take each individual structured data mechanism (e.g., xAPI statement) and concatenate them together to form a singular prompt. The system may feed that prompt into a large language model or other generative artificial intelligence model to generate a narrative summary of the user's performance. An example of such a summary is shown in user interface 400 in summary section 410.

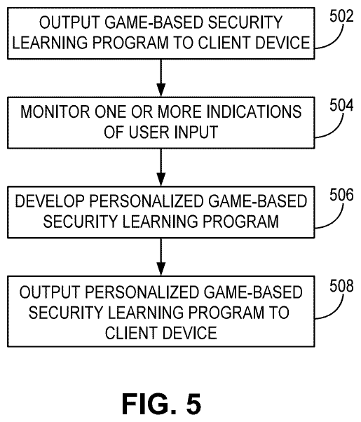

FIG. 5 is a flow chart illustrating an example mode of operation. The techniques of FIG. 5 may be performed by one or more processors of a computing device, such as system 100 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with the techniques described herein, communication module 220 outputs a game-based security learning program to a client device, the game-based security learning program comprising a first set of one or more adaptive learning modules (502). Learning module 222 monitors one or more indications of user input of a user of the client device within at least one of the first set of one or more adaptive learning modules of the game-based security learning program (504). Learning module 222 develops a personalized game-based security learning program for the user based on the one or more indications of user input of the user, the personalized game-based security learning program comprising a second set of one or more adaptive learning modules different than the first set of one or more adaptive learning modules (506). Communication module 220 outputs the personalized game-based security learning program to the client device (508).
Example 1. A method comprising: outputting, by one or more processors, a game-based security learning program to a client device, the game-based security learning program comprising a first set of one or more adaptive learning modules; monitoring, by the one or more processors, one or more indications of user input of a user of the client device within at least one of the first set of one or more adaptive learning modules of the game-based security learning program; developing, by the one or more processors, a personalized game-based security learning program for the user based on the one or more indications of user input of the user, the personalized game-based security learning program comprising a second set of one or more adaptive learning modules different than the first set of one or more adaptive learning modules; and outputting, by the one or more processors, the personalized game-based security learning program to the client device.
Example 2. The method of Example 1, further comprising: calculating, by the one or more processors, a human risk score for the user based at least in part on the one or more indications of user input.
Example 3. The method of any one or more of Examples 1-2, wherein monitoring the one or more indications of user input comprises developing, by the one or more processors, one or more structured data mechanisms for recording and reporting in-game behavior of the user, wherein developing the personalized game-based security learning program is based at least in part on the one or more structured data mechanisms.
Example 4. The method of Example 3, wherein the one or more structured data mechanisms each comprise an xAPI statement.
Example 5. The method of any one or more of Examples 1-4, wherein developing the second set of one or more adaptive learning modules for the personalized game-based security learning program comprises one or more of: changing, by the one or more processors, a difficulty of a first module in the first set of one or more adaptive learning modules to a different difficulty for a first module in the second set of one or more adaptive learning modules, removing, by the one or more processors, the first module from the first set of one or more adaptive learning modules from inclusion in the second set of one or more adaptive learning modules, adding, by the one or more processors, a new module to the second set of one or more adaptive learning modules, wherein the new module is not included in the first set of one or more adaptive learning modules, editing, by the one or more processors, the first module in the first set of one or more adaptive learning modules to develop an edited module for inclusion in the second set of one or more adaptive learning modules, and adding, by the one or more processors, an explanation within the first module in the first set of one or more adaptive learning modules to develop an explanatory module for inclusion in the second set of one or more adaptive learning modules.
Example 6. The method of any one or more of Examples 1-5, further comprising: determining, by the one or more processors, an interest level in a first subject type of module in the first set of one or more adaptive learning modules; determining, by the one or more processors, that the interest level meets a threshold interest level; and developing, by the one or more processors, the personalized game-based security learning program by adding additional modules of the first subject type to the second set of one or more adaptive learning modules.
Example 7. The method of any one or more of Examples 1-6, wherein monitoring the one or more indications of user input comprises determining, by the one or more processors, one or more activity characteristics of the one or more indications of user input, wherein developing the personalized game-based security learning program is based at least in part on the one or more activity characteristics of the one or more indications of user input.
Example 8. The method of Example 7, wherein the one or more activity characteristics comprise any one or more of: a speed of a response, an accuracy of the response, a type of security threat the user effectively handled, a progression of the user input towards a final accurate response, and an engagement of the user.
9. The method of any one or more of Examples 1-8, wherein monitoring the one or more indications of user input comprises tracking, by the one or more processors, a progress of the user towards mastering a particular skill competency.
Example 10. The method of any one or more of Examples 1-9, further comprising: tracking, by the one or more processors, performance for a plurality of users across an organization, wherein the performance comprises one or more of: an organizational score, a rank of the user within the organization, and a rank of the user within a role held by the user within the organization.
Example 11. The method of any one or more of Examples 1-10, wherein developing the personalized game-based security learning program further comprises: predicting, by the one or more processors, user performance in the personalized game-based security learning program based on the one or more indications of user input on the game-based security learning program; and preemptively adjusting, by the one or more processors, at least one module in the second set of one or more adaptive learning modules based on the predicted user performance.
Example 12. The method of any one or more of Examples 1-11, further comprising: constructing, by the one or more processors, a player profile for the user.
Example 13. The method of Example 12, wherein the player profile comprises information including one or more of: a job title of the user, a job responsibility list for the user, a game performance for the user, a human risk score for the user, an indication of areas of strength for the user, an indication of areas of weakness for the user, social media use for the user, dark web information of the user, a phishing simulation capability, and internet use descriptors for the user.
Example 14. The method of any one or more of Examples 12-13, wherein developing the personalized game-based security learning program comprises developing, by the one or more processors, the personalized game-based security learning program based on the player profile of the user.
Example 15. The method of any one or more of Examples 1-14, further comprising: concatenating, by the one or more processors, information descriptive of the one or more indications of user input into a prompt; feeding, by the one or more processors, the prompt into a large language model; and generating, by the one or more processors and using the large language model, a narrative summary of a performance of the user in the game-based security learning program.
Example 16. The method of any one or more of Examples 1-15, further comprising: analyzing, by the one or more processors and using an artificial intelligence model, one or more cybersecurity policies for an organization to develop one or more specific instructions for the personalized game-based security learning program relevant to the organization; and developing, by the one or more processors, the personalized game-based security learning program further based on the one or more specific instructions.
Example 17. The method of any one or more of Examples 1-16, further comprising: generating, by the one or more processors and using an artificial intelligence model, one or more custom communications for a user of the client device based on performance of the user during the personalized game-based security learning program; and outputting, by the one or more processors, at least one of the one or more custom communications to the client device.
Example 18. The method of any one or more of Examples 1-17, further comprising: generating, by the one or more processors and using an artificial intelligence model, a first request for input; outputting, by the one or more processors, the first request for input to an administrator device; receiving, by the one or more processors, an indication of first user input responding to the first request for input; generating, by the one or more processors, using the artificial intelligence model, and based at least in part on the first user input, a second request for input; outputting, by the one or more processors, the second request for input to the administrator device; receiving, by the one or more processors, an indication of second user input responding to the second request for input; and developing, by the one or more processors, the personalized game-based security learning program based at least in part on the first user input and the second user input.
Example 19. A method for performing any of the techniques of any combination of Examples 1-18.
Example 20. A device configured to perform any of the methods of any combination of Examples 1-18.
Example 21. An apparatus comprising means for performing any of the method of any combination of Examples 1-18.
Example 22. A non-transitory computer-readable storage medium having stored thereon instructions that, when executed, cause one or more processors of a computing device to perform the method of any combination of Examples 1-18.
Example 23. A system comprising one or more computing devices configured to perform a method of any combination of Examples 1-18.
Example 24. Any of the techniques described herein.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
outputting, by one or more processors, a game-based security learning program to a client device, the game-based security learning program comprising a first set of one or more adaptive learning modules;
monitoring, by the one or more processors, one or more indications of user input of a user of the client device within at least one of the first set of one or more adaptive learning modules of the game-based security learning program;
developing, by the one or more processors, a personalized game-based security learning program for the user based on the one or more indications of user input of the user, the personalized game-based security learning program comprising a second set of one or more adaptive learning modules different than the first set of one or more adaptive learning modules; and
outputting, by the one or more processors, the personalized game-based security learning program to the client device.

2. The method of claim 1, further comprising:
calculating, by the one or more processors, a human risk score for the user based at least in part on the one or more indications of user input.

3. The method of claim 1,
wherein monitoring the one or more indications of user input comprises developing, by the one or more processors, one or more structured data mechanisms for recording and reporting in-game behavior of the user,
wherein developing the personalized game-based security learning program is based at least in part on the one or more structured data mechanisms.

4. The method of claim 3, wherein the one or more structured data mechanisms each comprise an xAPI statement.

5. The method of claim 1, wherein developing the second set of one or more adaptive learning modules for the personalized game-based security learning program comprises one or more of:
changing, by the one or more processors, a difficulty of a first module in the first set of one or more adaptive learning modules to a different difficulty for a first module in the second set of one or more adaptive learning modules,
removing, by the one or more processors, the first module from the first set of one or more adaptive learning modules from inclusion in the second set of one or more adaptive learning modules,
adding, by the one or more processors, a new module to the second set of one or more adaptive learning modules, wherein the new module is not included in the first set of one or more adaptive learning modules,
editing, by the one or more processors, the first module in the first set of one or more adaptive learning modules to develop an edited module for inclusion in the second set of one or more adaptive learning modules, and
adding, by the one or more processors, an explanation within the first module in the first set of one or more adaptive learning modules to develop an explanatory module for inclusion in the second set of one or more adaptive learning modules.

6. The method of claim 1, further comprising:
determining, by the one or more processors, an interest level in a first subject type of module in the first set of one or more adaptive learning modules;
determining, by the one or more processors, that the interest level meets a threshold interest level; and
developing, by the one or more processors, the personalized game-based security learning program by adding additional modules of the first subject type to the second set of one or more adaptive learning modules.

7. The method of claim 1,
wherein monitoring the one or more indications of user input comprises determining, by the one or more processors, one or more activity characteristics of the one or more indications of user input,
wherein developing the personalized game-based security learning program is based at least in part on the one or more activity characteristics of the one or more indications of user input.

8. The method of claim 7, wherein the one or more activity characteristics comprise any one or more of:
a speed of a response,
an accuracy of the response,
a type of security threat the user effectively handled,
a progression of the user input towards a final accurate response, and
an engagement of the user.

9. The method of claim 1, wherein monitoring the one or more indications of user input comprises tracking, by the one or more processors, a progress of the user towards mastering a particular skill competency.

10. The method of claim 1, further comprising:
tracking, by the one or more processors, performance for a plurality of users across an organization, wherein the performance comprises one or more of:
an organizational score,
a rank of the user within the organization, and
a rank of the user within a role held by the user within the organization.

11. The method of claim 1, wherein developing the personalized game-based security learning program further comprises:
predicting, by the one or more processors, user performance in the personalized game-based security learning program based on the one or more indications of user input on the game-based security learning program; and
preemptively adjusting, by the one or more processors, at least one module in the second set of one or more adaptive learning modules based on the predicted user performance.

12. The method of claim 1, further comprising:
constructing, by the one or more processors, a player profile for the user.

13. The method of claim 12, wherein the player profile comprises information including one or more of:
a job title of the user,
a job responsibility list for the user,
a game performance for the user,
a human risk score for the user,
an indication of areas of strength for the user,
an indication of areas of weakness for the user,
social media use for the user,
dark web information of the user,
a phishing simulation capability, and
internet use descriptors for the user.

14. The method of claim 12, wherein developing the personalized game-based security learning program comprises developing, by the one or more processors, the personalized game-based security learning program based on the player profile of the user.

15. The method of claim 1, further comprising:
concatenating, by the one or more processors, information descriptive of the one or more indications of user input into a prompt;
feeding, by the one or more processors, the prompt into a large language model; and
generating, by the one or more processors and using the large language model, a narrative summary of a performance of the user in the game-based security learning program.

16. The method of claim 1, further comprising:
analyzing, by the one or more processors and using an artificial intelligence model, one or more cybersecurity policies for an organization to develop one or more specific instructions for the personalized game-based security learning program relevant to the organization; and
developing, by the one or more processors, the personalized game-based security learning program further based on the one or more specific instructions.

17. The method of claim 1, further comprising:
generating, by the one or more processors and using an artificial intelligence model, one or more custom communications for a user of the client device based on performance of the user during the personalized game-based security learning program; and
outputting, by the one or more processors, at least one of the one or more custom communications to the client device.

18. The method of claim 1, further comprising:
generating, by the one or more processors and using an artificial intelligence model, a first request for input;
outputting, by the one or more processors, the first request for input to an administrator device;
receiving, by the one or more processors, an indication of first user input responding to the first request for input;
generating, by the one or more processors, using the artificial intelligence model, and based at least in part on the first user input, a second request for input;
outputting, by the one or more processors, the second request for input to the administrator device;
receiving, by the one or more processors, an indication of second user input responding to the second request for input; and
developing, by the one or more processors, the personalized game-based security learning program based at least in part on the first user input and the second user input.

19. A computing device comprising one or more processors configured to:
output a game-based security learning program to a client device, the game-based security learning program comprising a first set of one or more adaptive learning modules;
monitor one or more indications of user input of a user of the client device within at least one of the first set of one or more adaptive learning modules of the game-based security learning program;
develop a personalized game-based security learning program for the user based on the one or more indications of user input of the user, the personalized game-based security learning program comprising a second set of one or more adaptive learning modules different than the first set of one or more adaptive learning modules; and
output the personalized game-based security learning program to the client device.

20. A non-transitory computer-readable storage medium having stored thereon instructions that, when executed, cause one or more processors of a computing device to:
output a game-based security learning program to a client device, the game-based security learning program comprising a first set of one or more adaptive learning modules;
monitor one or more indications of user input of a user of the client device within at least one of the first set of one or more adaptive learning modules of the game-based security learning program;
develop a personalized game-based security learning program for the user based on the one or more indications of user input of the user, the personalized game-based security learning program comprising a second set of one or more adaptive learning modules different than the first set of one or more adaptive learning modules; and
output the personalized game-based security learning program to the client device.
